(19) United States
(12) Patent Application Publication
(10) Pub. No.: US 2018/0224037 A1
(43) Pub. Date: Aug. 9, 2018

(54) CONNECTION STRUCTURE, FLEXIBLE TUBE AND CONNECTION METHOD

(71) Applicant: OLYMPUS CORPORATION, Tokyo (JP)

(72) Inventor: Kazuhiro YAMAGATA, Tokyo (JP)

(73) Assignee: OLYMPUS CORPORATION, Tokyo (JP)

(21) Appl. No.: 15/943,959

(22) Filed: Apr. 3, 2018

Related U.S. Application Data
(63) Continuation of application No. PCT/JP2016/078680, filed on Sep. 28, 2016.

(30) Foreign Application Priority Data
Oct. 5, 2015 (JP) 2015-197932

(51) Int. Cl. F16L 33/24; G02B 23/24

(52) U.S. Cl. CPC F16L 33/245; G02B 23/2476

(57) ABSTRACT

A connection structure includes: a first pipe member including a first fixing unit, a housing section, and an area closer to the second end side than the first fixing unit, the area being covered with an outer layer of the housing section; and a second pipe member including a two-stage structure including a first part, and a second part, a second fixing unit capable of being fixed to the first fixing unit, the second fixing unit being provided on an inner peripheral surface of the first part, and a positioning unit. The first pipe member is inserted into the second pipe member to determine positions with respect to each other by the positioning unit, the first and second fixing units are fixed to each other, and the outer layer is pressed and fixed to the first pipe member by the second part.

### CROSS-REFERENCE TO RELATED APPLICATIONS

This application is a continuation of PCT International Application No. PCT/JP2016/078680 filed on Sep. 28, 2016 which claims the benefit of priority from Japanese Patent Application No. 2015-197932, filed on Oct. 5, 2015, the entire contents of which are incorporated herein by reference.

### BACKGROUND

The present disclosure relates to a connection structure, a flexible tube, and a connection method.

An insertion unit included in an industrial endoscope has a structure with a rigid distal end provided with, for example, an imaging device, a freely curvable curved portion, and a long thin tube with flexibility, called a flexible tube or a corrugated tube, sequentially connected. Of these, the flexible tube houses, for example, an operating wire for operating the curved portion. The curved portion is coupled to a distal end of this flexible tube via a base (for example, see JP 2007-298815 A).

A method for manufacturing a flexible tube in the related art will be described with reference to FIG. 9. FIG. 9 is a partial sectional view illustrating a structure of a flexible tube in the related art. Firstly, a rigid part S is formed by covering an outer periphery of a flex 91 spirally wrapped with a belt-like metal plate with a metal blade (inner layer blade) 92 and joining the flex 91 and the inner layer blade 92 by soldering in an end area. Then, a flexible tube inner layer 94 is formed by forming a resin layer 93 around an outer periphery of the inner layer blade 92 by extrusion molding. Next, the resin layer 93 at a distal end of this flexible tube inner layer 94 is peeled off to expose at least a part thereof from a distal end side of the rigid part S, and after the exposed rigid part S is inserted into a base 96, the base 96 is fixed by adhesion and swaging. Furthermore, after the base 96 and the flexible tube inner layer 94 are covered with an outer layer blade 95, a part on which the base 96 is mounted is inserted and press-fitted into a metal ring 97 to fix the outer layer blade 95 by hardening an adhesive. Finally, an end of the outer layer blade 95 is cut to the base 96 to expose the base 96.

### SUMMARY

A connection structure according to one aspect of the present disclosure includes: a first pipe member in a cylindrical shape, including a first fixing unit capable of being fixed to another member, the first fixing unit being provided on an outer peripheral surface on a first end side in a rotational central axis direction, a housing section in a tubular shape connected on a second end side in the rotational central axis direction, and an area closer to the second end side than the first fixing unit, the area being covered with an outer layer of the housing section; and a second pipe member in a cylindrical shape including a two-stage structure including a first part having an inside diameter into which a part on the first end side of the first pipe member is inserted, and a second part having an inside diameter capable of inserting a part of the first pipe member covered with the outer layer, a second fixing unit capable of being fixed to the first fixing unit, the second fixing unit being provided on an inner peripheral surface of the first part, and a positioning unit configured to determine a position of the second pipe member with respect to the first pipe member in the rotational central axis direction, wherein the first pipe member is inserted into the second pipe member to determine positions with respect to each other by the positioning unit, the first and second fixing units are fixed to each other, and the outer layer is pressed and fixed to the first pipe member by the second part.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a pattern diagram illustrating a configuration of an endoscope to which a connection structure according to an embodiment is applied;

FIG. 2 is a sectional view illustrating a vicinity of a distal end of a flexible tube illustrated in FIG. 1;

FIG. 3 is a pattern diagram for describing a connection method according to an embodiment;

FIG. 4 is a pattern diagram for describing a connection method according to an embodiment;

FIG. 5 is a pattern diagram for describing a connection method according to an embodiment;

FIG. 6 is a pattern diagram for describing a connection method according to an embodiment;

FIG. 7 is a pattern diagram for describing a connection method according to an embodiment;

FIG. 8 is a pattern diagram for describing a connection method according to an embodiment; and

FIG. 9 is a partial sectional view illustrating a structure of a flexible tube with the related art.

### DETAILED DESCRIPTION

A connection structure according to embodiments will be described below with reference to the drawings. The present disclosure is not limited to these embodiments. In descriptions of the drawings, identical sections bear identical signs.

### Embodiments

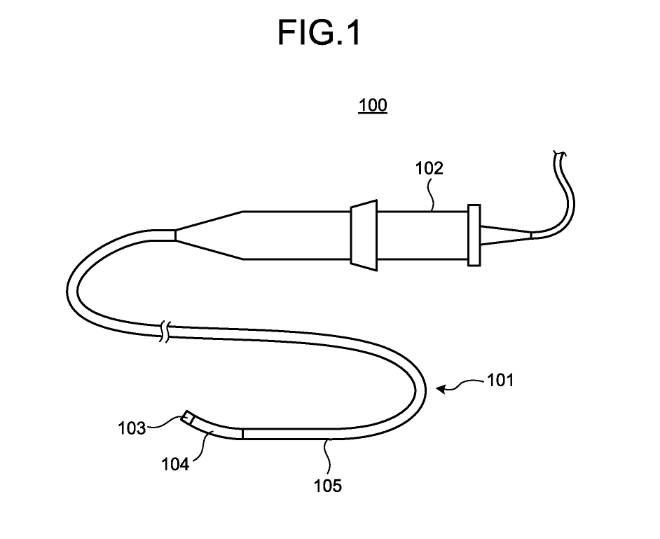

FIG. 1 is a pattern diagram illustrating a configuration of an endoscope to which a connection structure according to an embodiment is applied. An endoscope 100 illustrated in FIG. 1 includes an insertion unit 101 that is inserted into an inspection target and an operating unit 102 provided on a proximal end side of the insertion unit 101 for operating functions of an endoscope, and is used mainly for industrial uses.

The insertion unit 101 includes a distal end 103 provided with an imaging unit, a curved portion 104 connected with a proximal end side of the distal end 103 and freely curvable in a plurality of directions, and a flexible tube 105 connected with a proximal end side of the curved portion 104. The curved portion 104 curves by operation of a curve operation knob (not illustrated) provided in the operating unit 102 and is freely curvable in four directions such as upper, lower, left, and right, with towing and relaxing an operating wire inserted through the insertion unit 101.

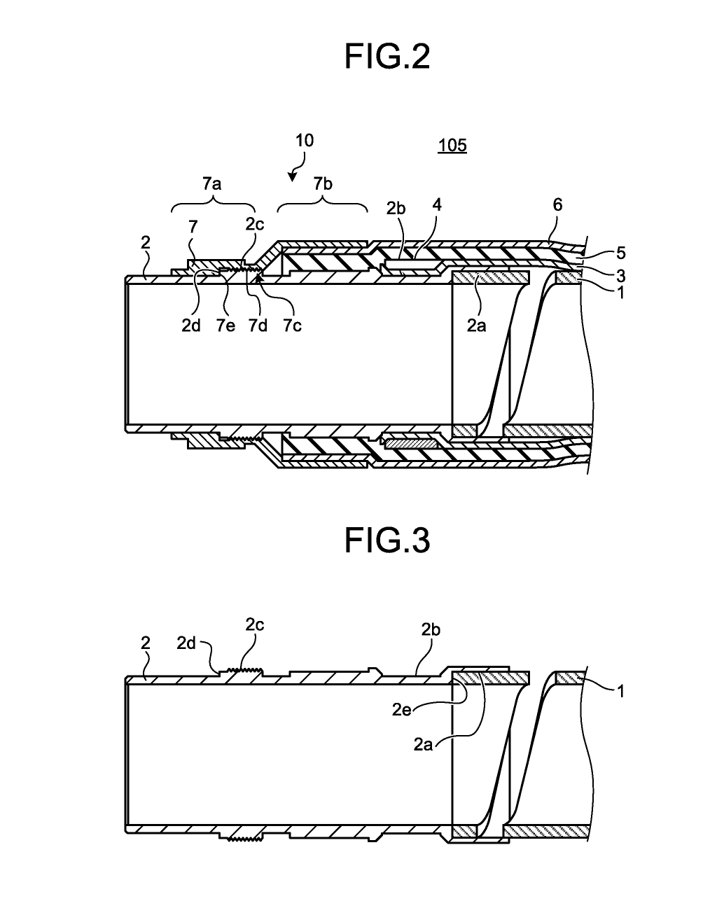

FIG. 2 is a sectional view illustrating a vicinity of a distal end of the flexible tube 105 illustrated in FIG. 1. As illustrated in FIG. 2, the flexible tube 105 includes a flex 1, a first pipe member 2 integrated with an end of the flex 1, an inner layer blade 3, a fixing ring 4 that fixes the inner layer blade 3 to the first pipe member 2, a resin layer 5, an outer layer blade 6, and a second pipe member 7 that fixes the outer layer blade 6 to the first pipe member 2. Of these, the first pipe member 2 is used as a base for mounting the flexible tube 105 on the curved portion 104 (see FIG. 1). In addition, the flex 1, the inner layer blade 3, the resin layer 5, and the outer layer blade 6 are included a tubular housing section that houses contents such as an operating wire. The connection structure according to the embodiment is a structure for connecting this tubular housing section to the first pipe member 2. In FIG. 2, a left-hand side is equivalent to a distal end side of the insertion unit 101 (see FIG. 1) and a right-hand side is equivalent to a proximal end side.

The flex 1 is a member spirally wrapped with a belt-like metal plate and forms a space that houses contents such as an operating wire.

The first pipe member 2 is a cylindrical metal member as a whole and a base mounted on the curved portion 104 (see FIG. 1) on one end side (distal end side) in a rotational central axis direction (horizontal direction in FIG. 2). The first pipe member 2 is also connected, on the other end side (proximal end side), to an end of the tubular housing section including the flex 1 and the inner layer blade 3 to the outer layer blade 6.

An area 2a on the proximal end side of the first pipe member 2 is excavated to enlarge an inside diameter compared with other areas. This area 2a is provided to integrate the flex 1 and the first pipe member 2 by fitting the flex 1 and to determine their positions. In addition, on an outer peripheral surface closer to the proximal end side of the first pipe member 2, a groove 2b for fitting the fixing ring 4 is formed. Furthermore, on an outer peripheral surface closer to the distal end side of the first pipe member 2, a screw section 2c is provided as a fixing unit that fixes a second pipe member 7 described later.

The inner layer blade 3 is a member obtained by tubularly braiding metallic fibers such as stainless and tungsten, or fibers obtained by mixing non-metallic fibers such as synthetic resins including polyester and carbon with these metallic fibers. The inner layer blade 3 covers ends of the flex 1 and the first pipe member 2 on the proximal end side and is fixed to the first pipe member 2 by the fixing ring 4.

The resin layer 5 is formed of thermoplastic elastomer based on, for example, urethane, polyester, nitrile, polyamide, polyimide, styrene, and olefin, thermoset elastomer, fluorine containing rubber, and synthetic resins such as fluorine containing resins and covers the inner layer blade 3 and a part of the first pipe member 2, specifically an area closer to the proximal end side than the screw section 2c. The inner layer blade 3 is impregnated and integrated with a part of the resin layer 5.

The outer layer blade 6 is a member obtained by tubularly braiding metallic fibers or mixed fibers similar to the inner layer blade 3 and covers the resin layer 5.

The second pipe member 7 is a cylindrical metallic member as a whole and a pipe member with a two-stage structure including a first part 7a with an inside diameter into which the distal end of the first pipe member 2 may be inserted and a second part 7b with an inside diameter into which a part of the first pipe member 2 covered with the outer layer blade 6 may be inserted.

An area 7c on the proximal end side of the first part 7a is excavated to enlarge an inside diameter compared with other areas. In this area 7c, a screw section 7d threadedly engageable with the screw section 2c of the first pipe member 2 is provided as a fixing unit. In addition, an end face 7e on the distal end side of the area 7c is an attachment face to which a side face 2d of the screw section 2c of the first pipe member 2 is attached and a positioning unit for determining a position to the first pipe member 2 in the rotational central axis direction.

Next, a connection method in a connection structure 10 illustrated in FIG. 2 will be described with reference to FIGS. 3 to 8. FIGS. 3 to 8 are pattern diagrams for describing a connection method according to the embodiment.

Firstly, as illustrated in FIG. 3, the end of the flex 1 is fitted into the area 2a on the proximal end side of the first pipe member 2. On this occasion, the flex 1 is positioned to the first pipe member 2 in the rotational central axis direction by attaching an end face of the flex 1 to an end face 2e of the area 2a. Furthermore, the flex 1 is joined to the first pipe member 2 with a publicly known joining technique such as soldering, welding, and press-fitting.

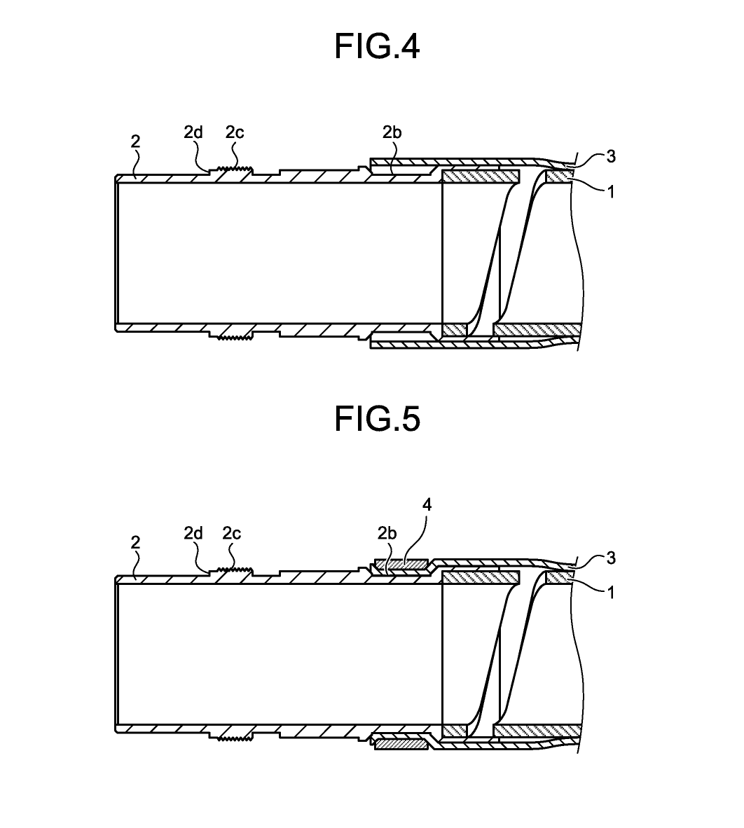

Then, as illustrated in FIG. 4, the flex 1 is covered with the inner layer blade 3. On this occasion, the inner layer blade 3 is drawn to a position to cover the groove 2b of the first pipe member 2.

Next, as illustrated in FIG. 5, the inner layer blade 3 is fixed to the first pipe member 2 by inserting the first pipe member 2 and the inner layer blade 3 through the fixing ring 4 and fixing the fixing ring 4 at a position of the groove 2b from an outer peripheral side of the inner layer blade 3 with a publicly known technique such as swaging.

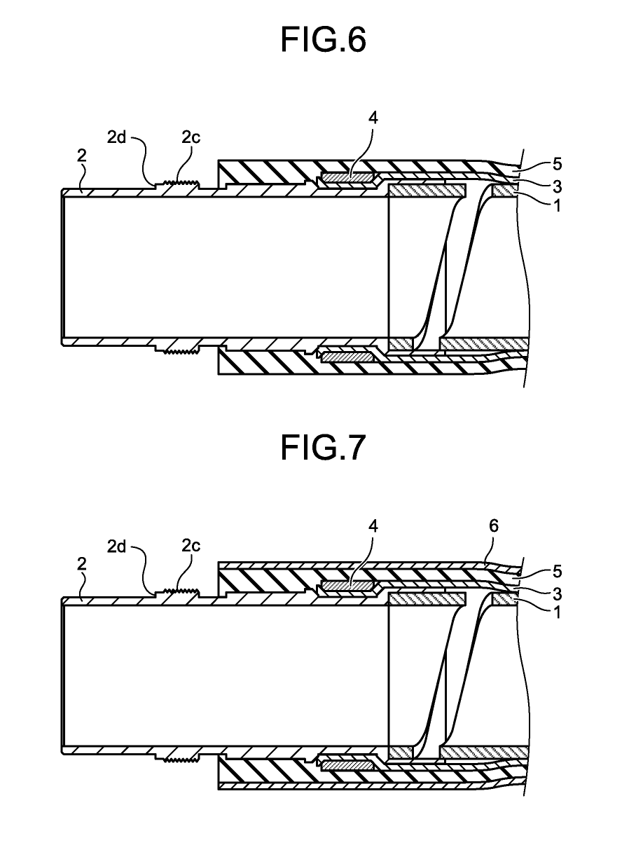

Then, as illustrated in FIG. 6, the inner layer blade 3 and a part of the first pipe member 2 are covered with the resin layer 5. The resin layer 5 is formed with a publicly known technique such as extrusion molding. On this occasion, in order to prevent attachment of resin to an area on the distal end side of the screw section 2c, it is preferable to form the resin layer 5 after the area is masked, for example.

Next, as illustrated in FIG. 7, the resin layer 5 is covered with the outer layer blade 6.

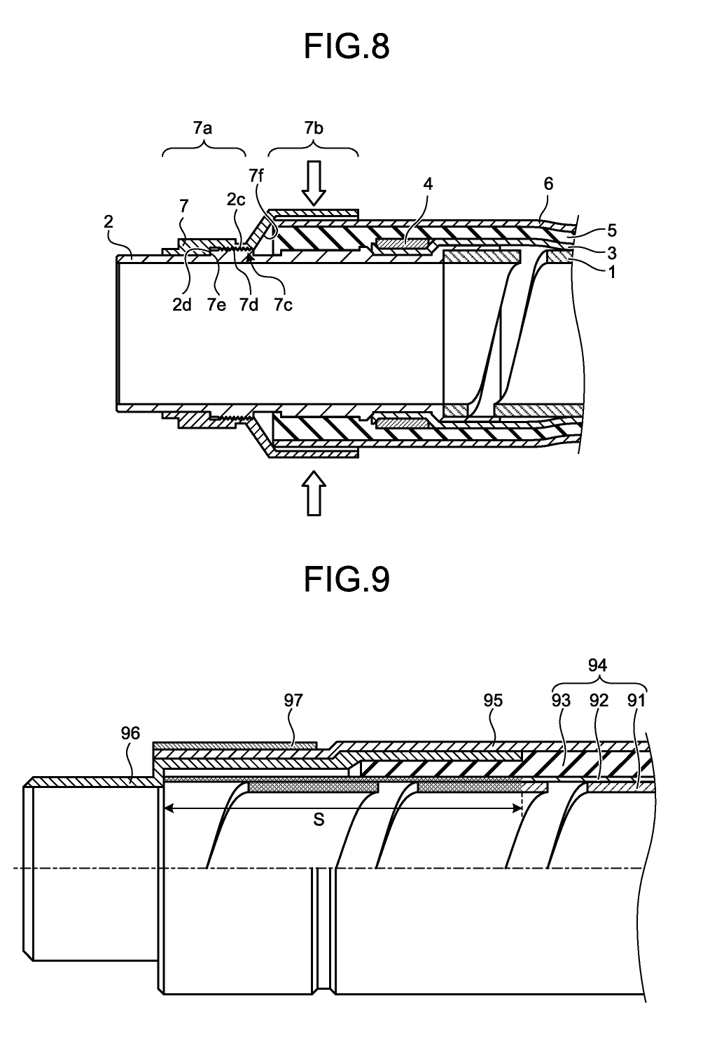

Then, as illustrated in FIG. 8, the first pipe member 2 is inserted through the second pipe member 7 to threadedly engage the screw section 2c of the first pipe member 2 with the screw section 7d of the second pipe member 7. On this occasion, the first pipe member 2 and the second pipe member 7 are positioned in the rotational central axis direction by screwing the first pipe member 2 until the side face 2d of the screw section 2c of the first pipe member 2 abuts on the end face 7e of the area 7c of the second pipe member 7.

According to the embodiment, an inner peripheral surface 7f, an area between the first part 7a and the second part 7b, has a diameter continuously enlarged such that a longitudinal section is tapered, and is designed to position the first pipe member 2 and the second pipe member 7 in the rotational central axis direction even when the end of the outer layer blade 6 is made abut on this inner peripheral surface 7f.

In this condition, there may be a slight clearance between an inner peripheral surface of the second part 7b of the second pipe member 7 and an outer peripheral surface of the outer layer blade 6. In other words, an inside diameter of the second part 7b is determined taking into account thickness and clearance of an entire outer layer of the tubular housing section including the resin layer 5 covering the first pipe member 2 and the outer layer blade 6.

Then, the second part 7b of the second pipe member 7 is subjected to swaging to reduce the second part 7b in diameter, and the outer layer blade 6 and the resin layer 5 are pressed and fixed to the first pipe member 2 by the second part 7b. As a result, the connection structure 10 illustrated in FIG. 2 is obtained.

As described above, according to the present embodiment, the first pipe member 2 and the second pipe member 7 are connected by threaded engagement with each other, and the outer layer blade 6 is fixed to the first pipe member 2 by swaging the second pipe member 7. Therefore, it is possible to reliably connect the tubular housing section including the flex 1 and the inner layer blade 3 to the outer layer blade 6 to the first pipe member 2 and to easily manufacture the flexible tube 105 with less variation in quality in a short time with less processes than before.

First Modification

In the embodiment above, the first pipe member 2 and the second pipe member 7 are connected by threaded engagement with each other, but a connection method between them is not limited to threaded engagement. For example, it is possible to form grooves that may be fitted into each other on an outer peripheral surface of the first pipe member 2 and an inner peripheral surface of the second pipe member 7 to fit them into each other in the grooves before rocking by relative rotation.

Second Modification

In the embodiment above, the first pipe member 2 is used as a base for mounting the flexible tube 105 on the curved portion 104 (see FIG. 1) by projecting the distal end of the first pipe member 2 outside that of the second pipe member 7. Conversely, however, the second pipe member 7 may be used as a base by projecting the distal end of the second pipe member 7 outside that of the first pipe member 2.

The present disclosure is not limited to the above embodiment and modifications and may be modified in various forms in accordance with, for example, specifications. For example, some components may be excluded from all components presented in the above embodiment and modifications. It is obvious from the above descriptions that embodiments in other various forms may be implemented in the scope of the present disclosure.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A connection structure comprising:
a first pipe member in a cylindrical shape, including
a first fixing unit capable of being fixed to another member, the first fixing unit being provided on an outer peripheral surface on a first end side in a rotational central axis direction,
a housing section in a tubular shape connected on a second end side in the rotational central axis direction, and
an area closer to the second end side than the first fixing unit, the area being covered with an outer layer of the housing section; and
a second pipe member in a cylindrical shape including
a two-stage structure including
a first part having an inside diameter into which a part on the first end side of the first pipe member is inserted, and
a second part having an inside diameter capable of inserting a part of the first pipe member covered with the outer layer,
a second fixing unit capable of being fixed to the first fixing unit, the second fixing unit being provided on an inner peripheral surface of the first part, and
a positioning unit configured to determine a position of the second pipe member with respect to the first pipe member in the rotational central axis direction,
wherein the first pipe member is inserted into the second pipe member to determine positions with respect to each other by the positioning unit,
the first and second fixing units are fixed to each other, and
the outer layer is pressed and fixed to the first pipe member by the second part.

2. The connection structure according to claim 1, wherein the first and second fixing units are screw sections threadedly engageable with each other.

3. The connection structure according to claim 2, wherein the positioning unit is an end face on which a side face of the screw section of the first pipe member is abuttable.

4. The connection structure according to claim 1, wherein the positioning unit is provided in an area between the first and second parts and is an inner peripheral surface on which an end of the outer layer is abuttable.

5. A flexible tube comprising:
a flex configured to demarcate a space that houses contents;
a first pipe member in a cylindrical shape, including a first fixing unit capable of being fixed to anther member on an outer peripheral surface on a first end side in a rotational central axis direction, the first pipe member being integrated with an end of the flex on a second end side in the rotational central axis direction;
an inner layer blade configured to cover the flex and a side closer to the second end than the first fixing unit of the first pipe member;
a resin layer configured to cover the inner layer blade and the side closer to the second end than the first fixing unit of the first pipe member;
an outer layer blade configured to cover the resin layer; and
a second pipe member in a cylindrical shape, including
a two-stage structure including
a first part having an inside diameter capable of inserting a part on the first end side of the first pipe member, and
a second part having an inside diameter capable of inserting a part of the first pipe member covered with the resin layer and the outer layer blade,
a second fixing unit capable of being fixed to the first fixing unit, the second fixing unit being provided on an inner peripheral surface of the first part, and
a positioning unit configured to determine a position with respect to the first pipe member in the rotational central axis direction,
wherein the first pipe member is inserted into the second pipe member to determine their positions with respect to each other by the positioning unit,
the first and second fixing units are fixed to each other, and
the outer layer blade and the resin layer are pressed and fixed to the first pipe member by the second part.

6. A connection method for a connection structure including:
a first pipe member in a cylindrical shape, including
a first fixing unit capable of being fixed to another member, the first fixing unit being provided on an outer peripheral surface on a first end side in a rotational central axis direction,
a housing section in a tubular shape connected on a second end side in the rotational central axis direction, and
an area closer to the second end side than the first fixing unit, the area being covered with an outer layer of the housing section; and
a second pipe member in a cylindrical shape including
a two-stage structure including
a first part having an inside diameter into which a part on the first end side of the first pipe member is inserted, and
a second part having an inside diameter capable of inserting a part of the first pipe member covered with the outer layer,
a second fixing unit capable of being fixed to the first fixing unit, the second fixing unit being provided on an inner peripheral surface of the first part, and
a positioning unit configured to determine a position of the second pipe member with respect to the first pipe member in the rotational central axis direction, the method comprising:
inserting the first pipe member into the second pipe member to determine their positions by the positioning unit;
fixing the first and second fixing units to each other; and
pressing and fixing the outer layer to the first pipe member by the second part through reduction of the second part in diameter.
